(19) United States
(12) Patent Application Publication
(10) Pub. No.: US 2014/0101033 A1
(43) Pub. Date: Apr. 10, 2014

(54) PAYMENT PREFERENCE USER INTERFACE

(71) Applicants: Matthew Lyles, Campbell, CA (US); Libo Su, San Jose, CA (US); Michael Hwang, Sunnyvale, CA (US); Egan Schulz, San Jose, CA (US)

(72) Inventors: Matthew Lyles, Campbell, CA (US); Libo Su, San Jose, CA (US); Michael Hwang, Sunnyvale, CA (US); Egan Schulz, San Jose, CA (US)

(21) Appl. No.: 14/045,498

(22) Filed: Oct. 3, 2013

Related U.S. Application Data
(60) Provisional application No. 61/709,840, filed on Oct. 4, 2012.

(51) Int. Cl. G06Q 20/22

(52) U.S. Cl. CPC G06Q 20/227
USPC 705/39

(57) ABSTRACT

A user is presented, on a user device display, with two rows of available funding sources to select from to add as a primary funding source (e.g., first row) and secondary or backup funding source (e.g., second row). Once a funding source is selected, the selected funding source is deactivated in the other row so that it cannot be selected in the other row. Selected funding sources are shown in different colors for the primary source and the backup source in the order of the display.

### CROSS REFERENCE TO RELATED APPLICATION

The present application claims priority to U.S. Provisional Patent Appl. Ser. No. 61/709,840, filed Oct. 4, 2012, which is incorporated by reference in its entirety.

### BACKGROUND

1. Technical Field

The present application generally relates to online accounts and more particularly to selecting funding sources for online accounts.

2. Related Art

Online account service providers are available to provide numerous services to users. In one example, a payment provider, such as PayPal, Inc. of San Jose, Calif., provides payment services to users that allow users to make electronic payments. Payments can be for gifts, fund transfers, purchases from merchants, donations, services, etc. In a typical online account, the user is required to have at least one funding source associated with the account to fund purchases and payments. Many times, the funding source may not be available, such as being expired, not enough funds, not enough credit, etc. Thus, online account providers may also require the user to select a secondary or backup funding source in the event the primary funding source cannot be used to fully fund a payment or purchase.

The user may be asked to enter one or more additional funding sources (in addition to the primary funding source) and then select a desired backup funding source. For example, the user may be shown a list of available funding sources and asked to select a backup funding source by tapping or placing a check mark by the funding source. The primary funding source may also be listed. After selection, the user typically has to go into account settings to edit or change one or more of the funding sources, which can be time-consuming and not visually intuitive.

### BRIEF DESCRIPTION OF THE DRAWINGS

FIG. 1 is a flowchart showing a process a service provider makes in conducting funding source selection according to one embodiment;

FIGS. 2A-2C are sample screenshots showing a process for a user to select a payment or funding source, according to one embodiment;

FIGS. 3A-3C show another set of exemplary screenshots according to another embodiment;

FIGS. 4A-4C show another set of exemplary screenshots according to another embodiment;

FIGS. 5A and 5B show another set of exemplary screen shots according to another embodiment;

FIGS. 6A-6C show exemplary screen shots according to another embodiment;

FIG. 7 is block diagram of a networked system suitable for implementing the process described herein according to an embodiment; and

FIG. 8 is a block diagram of a computer system suitable for implementing one or more components in FIG. 7 according to one embodiment.

### DETAILED DESCRIPTION

In one embodiment, a user is presented, on a user device display, with two rows of available funding sources to select from to add as a primary funding source (e.g., first row) and secondary or backup funding source (e.g., second row). Once a funding source is selected, the selected funding source is deactivated and/or changes color in the other row so that it cannot be selected in the other row. Selected funding sources are shown in different colors for the primary source and the backup source in the order of the display. For example, assume there are six available funding sources in the following order: Visa A, Visa B, PayPal, Balance, Citibank Account, American Express, and Chase. The user may select American Express as the primary payment or funding source and PayPal Balance as the backup payment or funding source. In that case, for example, a row of six shapes are shown across a top of a user display, with the third one (representing PayPal Balance) shown in pink (for secondary) and the fifth one (representing American Express) shown in blue (for primary). The rest remain colorless or the same color. In other embodiments, the funding source selection may be for other purposes and not for selection of a primary and a secondary funding source.

Thus, the user is presented with an easy interface to select available funding sources for the user's payment account.

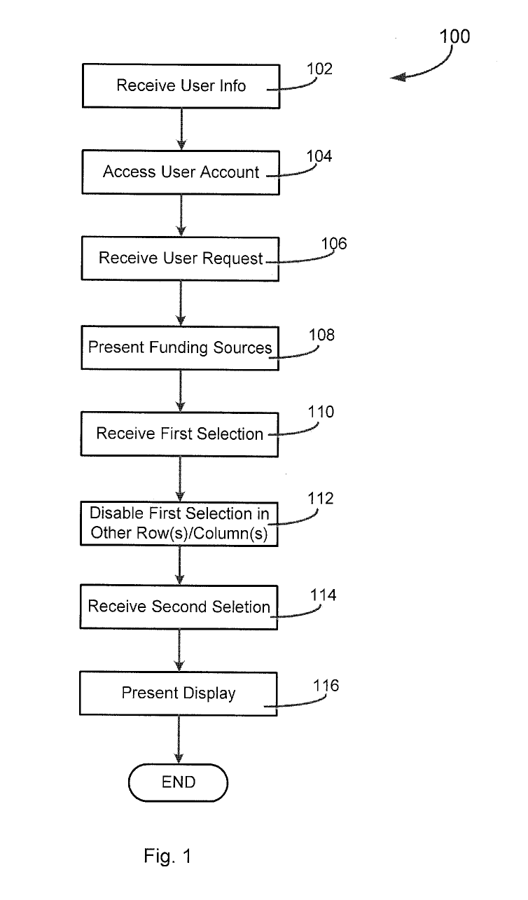

FIG. 1 is a flowchart 100 showing a process a service provider makes in conducting funding source selection according to one embodiment. At step 102, a service provider receives user information electronically from a user device, such as a mobile phone, computing tablet, PC, wearable computing device (e.g., Google Glass or smart watch) or the like. The user information enables the service provider to access an account of the user or otherwise identify the user. Examples of user information include a user name, email address, phone number, along with a password or PIN.

At step 104, the service provider accesses the user's account, such as by searching a database, memory, or storage of user accounts, using one or more user identifiers and/or a password/PIN. If an account is located corresponding to the user identifier, the password or PIN may be checked to determine whether it matches with the user entered password or PIN. If there is a match, the user is authenticated. However, if an account cannot be found and/or the password/PIN does not match, the user may be asked to reenter a user identifier and/or a password/PIN.

Once the user account is accessed, the user may be shown a home page for the user account. The home page may include an option, such as a tab, link, or button, for viewing, adding, or changing a funding source or payment instrument associated with or linked to the user account. User selection of the option communicates the corresponding request from the user, which is received by the service provider, at step 106.

At step 108, the service provider retrieves available funding sources associated with the user account and presents these available funding sources to the user on the user device. Only available funding sources may be shown, such that expired funding sources are not shown. In another embodiment, expired funding sources are shown, but visually indicated that they are not selectable due to expiration. In that case, the user may select the funding source to update information, such as a new expiration date and CVV code.

In one embodiment, a first row of funding sources is shown as possible primary funding sources, and a second row of the same or subset of the funding sources in the first row is shown as possible secondary or backup funding sources. In other embodiments, the funding sources can be shown in different configurations, such as arranged in columns, as opposed to rows. The funding sources may be shown as selectable images that may include text and/or images to identify each specific funding source. The images may have the general appearance or look associated with the particular funding source, including color, name, logo, etc. The funding sources may be shown in a specific or random order. For example, the funding sources may be shown in alphabetical order, by the order in which the user linked the source to the account (e.g., first linked source shown first and last linked source shown last), sources desired by the service provider shown first (e.g., bank accounts shown before credit card accounts), or by an order selected by the user.

In one embodiment, depending on the action desired, the funding sources may be displayed differently. For example, if both the primary and backup funding source had previously been selected, but the user wishes to change one or both funding sources, the user may see a visual indication of the currently selected primary and backup funding sources, such as with a check mark, bolded, highlighted, different color, etc.

Next, at step 110, the service provider receives a first selection from the user, where the user selects a displayed funding source as a primary or secondary funding source for the account. The user may select the desired funding source by tapping or otherwise selecting the source from the display.

The selection is communicated to the service provider, which then stores the selection and disables the selected funding source, at step 112, as an option for any other user selections for funding source selection. For example, if the user selects funding source 2 as a primary funding source, funding source 2 is not available for selection as a backup funding source. Note that the first selection may be for a backup funding source, such that the selected funding source is disabled for selection as a primary funding source. The disabled funding source may be shown in grey or a different color or brightness and/or not be active or selectable by the user anymore, i.e., the user can tap the disabled funding option image, but nothing happens, or a message appears that the funding source cannot be used and to select another funding source.

Thus, the user is presented with only available funding options for a next or subsequent selection, such as for a secondary or backup funding source. The user may then make a second selection of a desired funding source, different from the first selection, to be used as a backup funding source (or primary if the first selection was for the backup funding source). Selection can be the same as with the first selection, such as the user tapping, placing a corresponding check mark, or other means. The second selection is then received by the service provider, at step 114, and stored.

The user selections may then be presented to the user on the user device at step 116. The user may change one or more selections as desired, confirm/accept the selections, exit the account, or proceed with additional transactions within the account.

In another embodiment, the available funding sources are shown without being separated by primary and backup funding sources. For example, the available funding sources may be shown in a single row or column. The user is then asked to select one or more funding sources depending on the action desired. For example, if a primary funding source is needed, the user is asked to select a primary funding source from the display. If a backup funding source is needed, the user is asked to select a backup funding source from the same display. The funding source already selected may be highlighted, omitted, or made inactive so that the user cannot select the same funding source for both the primary and backup funding source. Once selected, the single row or column may indicate both the primary and backup funding source, such as by different colors, text, highlighting, etc.

Thus, the user is able to quickly and easily add/change funding sources and visually identify selected funding sources.

Note that one or more of the steps described herein may be omitted, combined, or performed in a different sequence as desired and suitable.

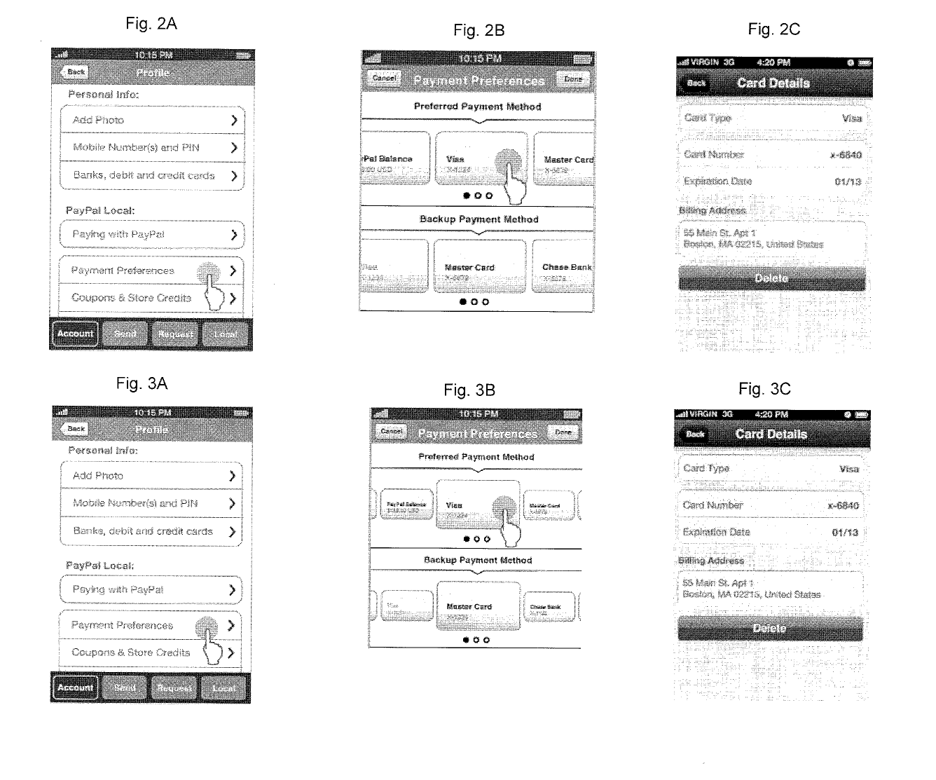

FIGS. 2A-2C are sample screenshots showing a process for a user to select a payment or funding source, according to one embodiment. In FIG. 2A, the user has accessed or logged into the user account with a service provider and is shown a profile page, which may be the initial page or screen after login or after the user selects the profile page from the account home screen. The user then selects or taps the payment preferences option to view and/or select or change funding sources. In FIG. 2B, the user sees a top row of three available primary or preferred funding sources and a bottom row of three available backup funding sources. A row of dots indicates the number of funding sources in the row (three in this example). Initially, before selection, the funding sources may be shown in the same order for both rows. In another embodiment, if a funding source has been selected for the primary and/or backup funding source, the selected source may be shown in the center of the display or row.

As shown in FIG. 2B, the user selects the Visa card as the primary funding source by tapping on the image or icon. The Visa option for the backup funding source is then greyed out and inactivated in the backup funding source display or row. At the same time, the Visa option is moved away from the center of the display in the backup funding source display row. Additional information about a funding source can be shown to the user, such as in FIG. 2C, when the user taps or selects the desired funding source. As shown in FIG. 2C, upon selection of the Visa card, the user may see a display with details of the selected funding source, such as a flip or zoom-in animation showing card type, card number, expiration date, billing address, and other relevant information.

FIGS. 3A-3C show a set of exemplary screenshots according to another embodiment. In FIG. 3A, the user has accessed the user account and selected the payment preferences option as in FIG. 2A. Available payment options are shown in FIG. 3B, but this time the payment option in the center of the display is enlarged for selection if desired. If the user wishes to select a different payment option, the user can scroll right or left to place a desired payment option in the center for enlargement and selection. As with the embodiment shown in FIG. 2B, once a payment source is selected, that same source is inactivated or otherwise modified such that the user cannot select the same payment source for another purpose. In FIG. 3C, the user sees details of the selected funding source, as in FIG. 2C.

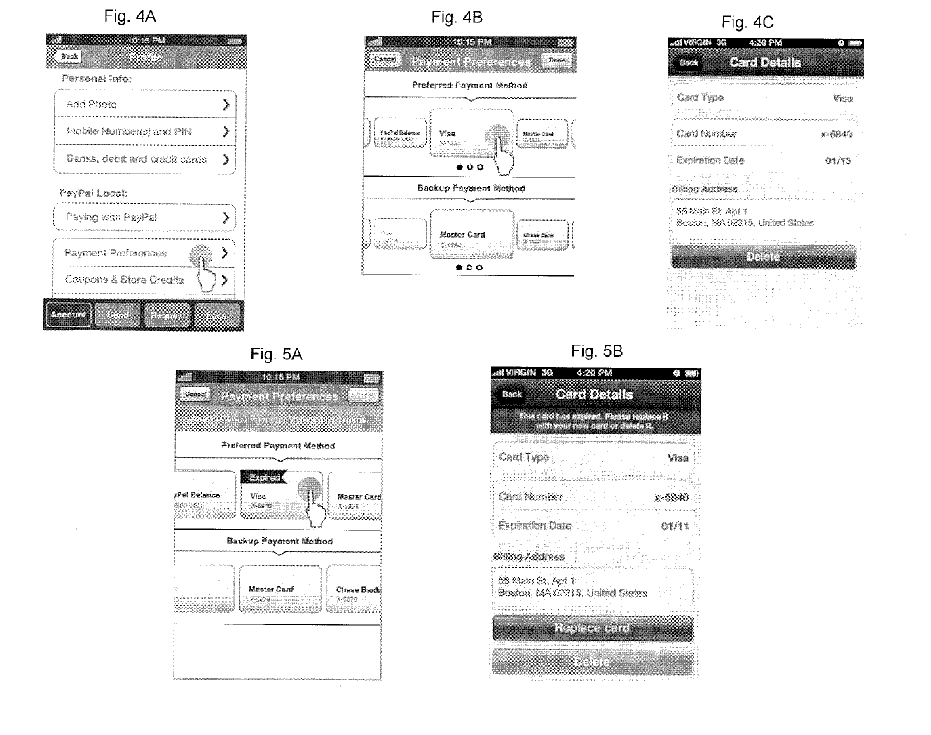

FIGS. 4A-4C show a set of exemplary screenshots according to another embodiment. In FIG. 4A, the user has accessed the user account and selected the payment preferences option as in FIGS. 2A and 3A. Available payment options are shown in FIG. 4B, as in FIGS. 2B and 3B, but this time, all available payment options are shown on an additional top row. In FIG. 4B, there are five funding source options, shown as five rectangles. The user then selects a primary funding source (by selecting a desired funding source from the preferred payment method row) and a backup funding source (by selecting a desired funding source from the backup payment method row). As with the previous embodiments, once a funding source is selected, it cannot be selected again. After selection, the selected primary funding source is shown in a first color (e.g., blue) in the top row, and the selected backup funding source is shown in a second different color (e.g. pink). In FIG. 4B, the Visa card is the second available funding option (second rectangle colored blue as the primary source), and the Master Card is the third available funding option (third rectangle colored pink as the backup source). In other embodiments, the primary finding source and the backup funding source may be visually identified in different ways, such as with different bolded or intensity levels. In FIG. 4C, the user sees details of the selected funding source, as in FIGS. 2C and 3C.

FIGS. 5A and 5B show a set of exemplary screen shots according to another embodiment. In FIG. 5A, the user is shown all funding sources for selection as a primary payment source and as a backup payment source. Of note is that the user sees not only available funding sources, but also ones that are associated with the user account that may not be active or readily available. For example, FIG. 5A shows a linked Visa card that has expired, which is visually noted to the user with a colored ribbon/banner. The user can then select the expired card to see details of the card in FIG. 5B. The user can then update or replace the card as desired. Once updated, the user can select the recently activated funding source or any other available funding source as a primary or backup funding source as discussed herein.

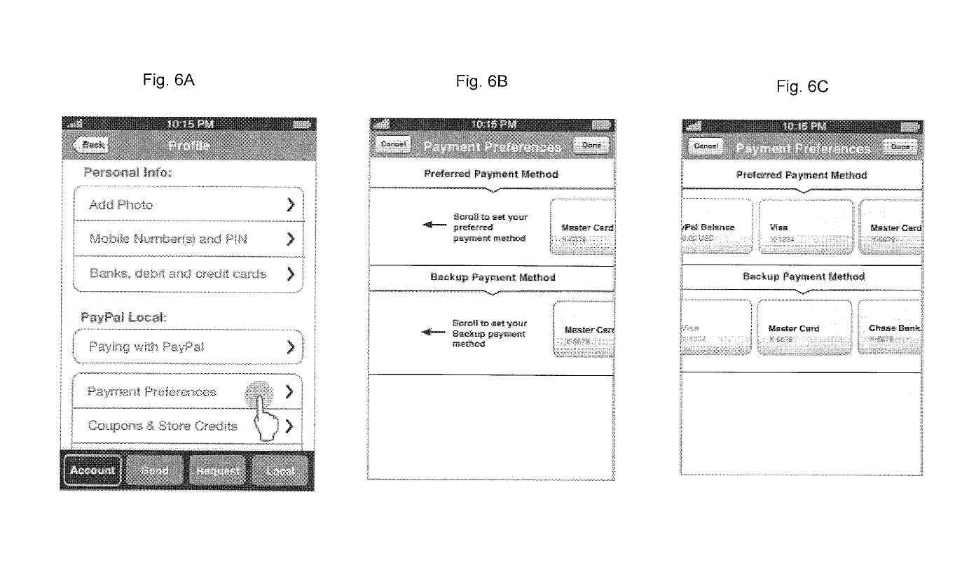

FIGS. 6A-6C show exemplary screen shots according to another embodiment. FIG. 6A is the same as in other embodiments above. FIG. 6B shows the user instructions about how to navigate through available funding source options. Both rows instruct the user, with text and an arrow, to scroll or move horizontally to see different funding source options. The user may then scroll, such as with a finger or mouse, to see funding sources to the right, as seen in FIG. 6C. The user may then continue with selection of desired funding sources for a primary and/or a backup funding source as described with other embodiments.

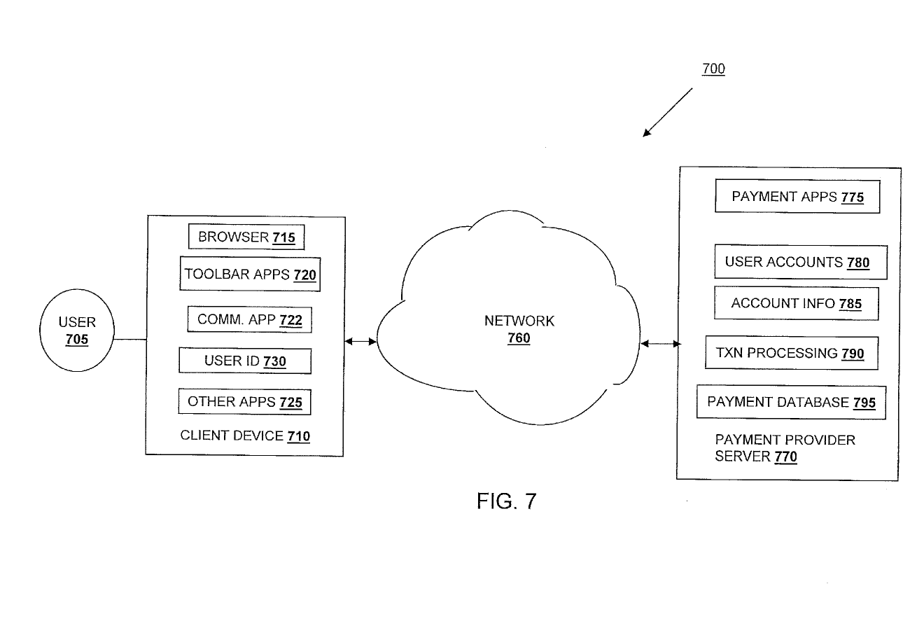

FIG. 7 is a block diagram of a networked system 700 configured to allow a user to select a funding source, such as described above, in accordance with an embodiment of the invention. System 700 includes a user device 710 and a payment provider server 770 in communication over a network 760. Payment provider server 770 may be maintained by a payment provider, such as PayPal, Inc. of San Jose, Calif. Although a payment provider device is shown, the server may be managed or controlled any suitable service provider that requires authentication as a human before communicating information. A user 705 utilizes user device 710 to view account information and perform transaction using payment provider server 770. Note that transaction, as used herein, refers to any suitable action performed using the user device, including payments, transfer of information, display of information, etc. Although only one server is shown, a plurality of servers may be utilized. Exemplary servers may include, for example, stand-alone and enterprise-class servers operating a server OS such as a MICROSOFT® OS, a UNIX® OS, a LINUX® OS, or other suitable server-based OS. One or more servers may be operated and/or maintained by the same or different entities.

User device 710 and payment provider server 770 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760.

Network 760 may be implemented as a single network or a combination of multiple networks. For example, in various embodiments, network 760 may include the Internet or one or more intranets, landline networks, wireless networks, and/or other appropriate types of networks.

User device 710 may be implemented using any appropriate hardware and software configured for wired and/or wireless communication over network 760. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 710 may include one or more browser applications 715 which may be used, for example, to provide a convenient interface to permit user 705 to browse information available over network 760. For example, in one embodiment, browser application 715 may be implemented as a web browser configured to view information available over the Internet, such as authentication tests and information from the payment provider. User device 710 may also include one or more toolbar applications 720 which may be used, for example, to provide client-side processing for performing desired tasks in response to operations selected by user 705. In one embodiment, toolbar application 720 may display a user interface in connection with browser application 715 as further described herein.

User device 710 may further include other applications 725 as may be desired in particular embodiments to provide desired features to user device 710. For example, other applications 725 may include security applications for implementing client-side security features, programmatic client applications for interfacing with appropriate application programming interfaces (APIs) over network 760, or other types of applications. Applications 725 may also include email, texting, voice and IM applications that allow user 705 to send and receive emails, calls, and texts through network 760, as well as applications that enable the user to communicate and transfer information through the payment provider as discussed above. User device 710 includes one or more user identifiers 730 which may be implemented, for example, as operating system registry entries, cookies associated with browser application 715, identifiers associated with hardware of user device 710, or other appropriate identifiers, such as used for payment/user/device authentication. In one embodiment, user identifier 730 may be used by a payment service provider to associate user 705 with a particular account maintained by the payment provider. A communications application 722, with associated interfaces, enables user device 710 to communicate within system 700.

Payment provider server 770 may be maintained, for example, by an online payment service provider which may provide information to and receive information from user 705, such as for making payments. In this regard, payment provider server 770 includes one or more payment applications 775 which may be configured to interact with user device 710 over network 760 to facilitate sending payments from user 705 of user device 710.

Payment provider server 770 also maintains a plurality of user accounts 780, each of which may include account information 785 associated with consumers, merchants, and funding sources, such as credit card companies. For example, account information 785 may include private financial information of users of devices such as account numbers, passwords, device identifiers, user names, phone numbers, credit card information, bank information, identification cards, photos, or other information which may be used to facilitate transactions by user 705.

A transaction processing application 790, which may be part of payment application 775 or separate, may be configured to receive information from a user device for processing and storage in a payment database 795. Transaction processing application 790 may include one or more applications to process information from user 705 for processing a payment using various selected funding instruments or cards. As such, transaction processing application 790 may store details of an order from individual users, including funding source(s) used, credit options available, etc. Payment application 775 may be further configured to determine the existence of and to manage accounts for user 705, as well as create new accounts if necessary, such as the set up and management payments by the user.

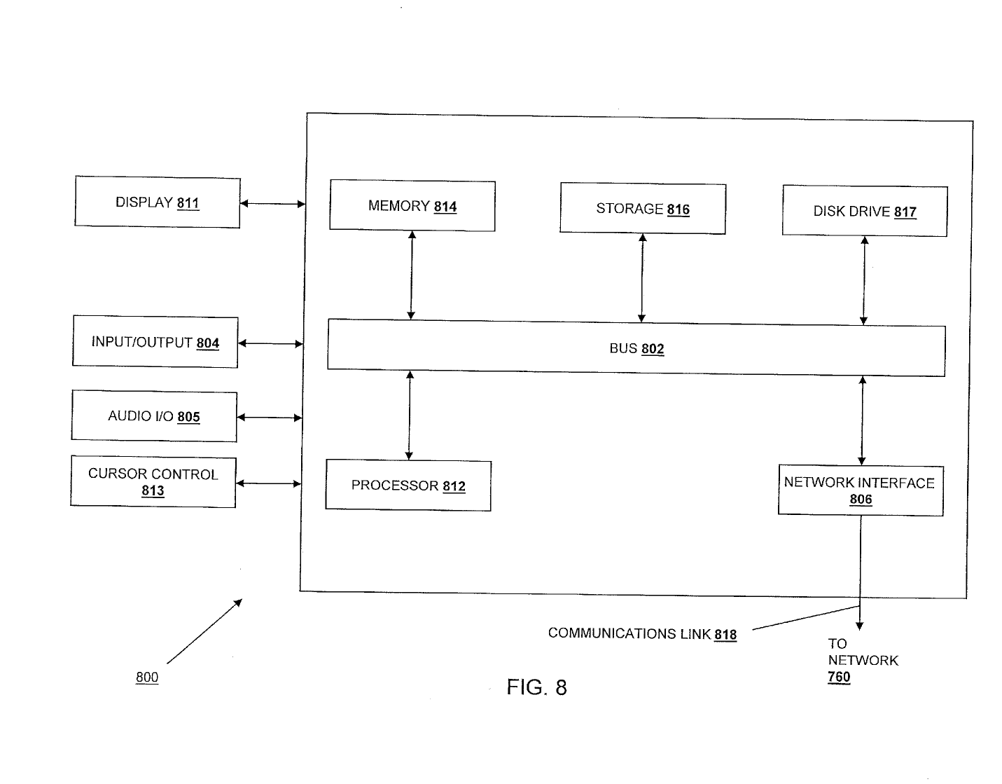

FIG. 8 is a block diagram of a computer system 800 suitable for implementing one or more embodiments of the present disclosure. In various implementations, the user device may comprise a personal computing device (e.g., smart phone, a computing tablet, a personal computer, laptop, PDA, Bluetooth device, key FOB, badge, wearable computing device, etc.) capable of communicating with the network. The payment provider may utilize a network computing device (e.g., a network server) capable of communicating with the network. It should be appreciated that each of the devices utilized by users and payment providers may be implemented as computer system 800 in a manner as follows.

Computer system 800 includes a bus 802 or other communication mechanism for communicating information data, signals, and information between various components of computer system 800. Components include an input/output (I/O) component 804 that processes a user action, such as selecting keys from a keypad/keyboard, selecting one or more buttons, image, or links, etc., and sends a corresponding signal to bus 80.2. I/O component 804 may include a camera or other image capture device for capturing an image of a user card. I/O component 804 may also include an output component, such as a display 811 and a cursor control 813 (such as a keyboard, keypad, mouse, etc.). An optional audio input/output component 805 may also be included to allow a user to use voice for inputting information by converting audio signals. Audio I/O component 805 may allow the user to hear audio. A transceiver or network interface 806 transmits and receives signals between computer system 800 and other devices, such as another user device, a merchant server, or a payment provider server via network 760. In one embodiment, the transmission is wireless, although other transmission mediums and methods may also be suitable. A processor 812, which can be a micro-controller, digital signal processor (DSP), or other processing component, processes these various signals, such as for display on computer system 800 or transmission to other devices via a communication link 818. Processor 812 may also control transmission of information, such as cookies or IP addresses, to other devices.

Components of computer system 800 also include a system memory component 814 (e.g., RAM), a static storage component 816 (e.g., ROM), and/or a disk drive 817. Computer system 800 performs specific operations by processor 812 and other components by executing one or more sequences of instructions contained in system memory component 814. Logic may be encoded in a computer readable medium, which may refer to any medium that participates in providing instructions to processor 812 for execution. Such a medium may take many forms, including but not limited to, non-volatile media, volatile media, and transmission media. In various implementations, non-volatile media includes optical or magnetic disks, volatile media includes dynamic memory, such as system memory component 814, and transmission media includes coaxial cables, copper wire, and fiber optics, including wires that comprise bus 802. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 800. In various other embodiments of the present disclosure, a plurality of computer systems 800 coupled by communication link 818 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. For example, the interface described above is directed to selection of funding sources. However, user selections other than payment or funding sources may also be suitable where once one selection is made, the selection cannot be selected again. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing information about funding sources for user accounts; and
one or more hardware processors in communication with the non-transitory memory and configured for:
communicating, electronically to a user device, data that enables the user device to display a plurality of first funding sources for a first use and a plurality of second funding sources for a second use, wherein at least one of the first funding sources is in the plurality of second funding sources;
receiving a first selection from the plurality of first funding sources for the first use;
disabling the first selection for the second use; and
receiving a second selection from the plurality of second funding sources for the second use.

2. The system of claim 1, wherein the disabling comprises deactivating the first selection so that the user is unable to select the first selection for the second use.

3. The system of claim 2, wherein the disabling comprises changing a color of the first selection.

4. The system of claim 1, wherein the plurality of first funding sources is displayed in a user-movable first row and the plurality of second funding sources is displayed in a user-movable second row.

5. The system of claim 1, wherein the user is presented with a number of visual images representing at least the first funding sources and/or the second funding sources.

6. The system of claim 5, wherein the number is a number of funding sources available for the user to select.

7. The system of claim 6, wherein a first visual image is shown in a first color corresponding to the first selection, and a second visual image is shown in a second color corresponding to the second selection.

8. The system of claim 6, wherein the visual images are arranged in a same sequence as the funding sources shown to the user.

9. A method comprising:
receiving, electronically by a hardware processor of a payment provider, a user account identifier;
accessing, electronically by the hardware processor, the user account based, in part, on the user account identifier;
communicating, electronically to a user device, data that enables the user device to display a plurality of first funding sources for a first use and a plurality of second funding sources for a second use associated with the user account, wherein at least one of the first funding sources is in the plurality of second funding sources;
receiving a first selection from the plurality of first funding sources for the first use;
disabling the first selection for the second use; and
receiving a second selection from the plurality of second funding sources for the second use.

10. The method of claim 9, wherein the disabling comprises deactivating the first selection so that the user is unable to select the first selection for the second use.

11. The method of claim 9, wherein the plurality of first funding sources is displayed in a user-movable first row and the plurality of second funding sources is displayed in a user-movable second row.

12. The method of claim 9, wherein the user is presented with a number of visual images representing at least the first funding sources and/or the second funding sources.

13. The method of claim 12, wherein the number is a number of funding sources available for the user to select.

14. The method of claim 13, wherein a first visual image is shown in a first color corresponding to the first selection, and a second visual image is shown in a second color corresponding to the second selection.

15. The method of claim 13, wherein the visual images are arranged in a same sequence as the funding sources shown to the user.

16. A non-transitory computer readable medium comprising a plurality of machine-readable instructions which when executed by one or more processors of a server are adapted to cause the server to perform a method comprising;
communicating, electronically to a user device, data that enables the user device to display a plurality of first funding sources for a first use and a plurality of second funding sources for a second use, wherein at least one of the first funding sources is in the plurality of second funding sources;
receiving a first selection from the plurality of first funding sources for the first use;
disabling the first selection for the second use; and
receiving a second selection from the plurality of second funding sources for the second use.

17. The non-transitory computer readable medium of claim 16, wherein the disabling comprises deactivating the first selection so that the user is unable to select the first selection for the second use.

18. The non-transitory computer readable medium of claim 16, wherein the plurality of first funding sources is displayed in a user-movable first row and the plurality of second funding sources is displayed in a user-movable second row.

19. The non-transitory computer readable medium of claim 16, wherein the user is presented with a number of visual images representing at least the first funding sources and/or the second funding sources.

20. The non-transitory computer readable medium of claim 19, wherein the number is a number of funding sources available for the user to select.

21. The non-transitory computer readable medium of claim 20, wherein a first visual image is shown in a first color corresponding to the first selection, and a second visual image is shown in a second color corresponding to the second selection.

22. The non-transitory computer readable medium of claim 21, wherein the visual images are arranged in a same sequence as the funding sources shown to the user.
